(19) United States
(12) Patent Application Publication
(10) Pub. No.: US 2013/0122161 A1
(43) Pub. Date: May 16, 2013

(54) METHOD AND APPARATUS FOR ALTERING THE COMPOSITION OF A BEVERAGE

(71) Applicants: Joseph W. Cole, Las Vegas, NV (US); Elia Rocco Tarantino, Las Vegas, NV (US)

(72) Inventors: Joseph W. Cole, Las Vegas, NV (US); Elia Rocco Tarantino, Las Vegas, NV (US)

(21) Appl. No.: 13/717,271

(22) Filed: Dec. 17, 2012

Related U.S. Application Data
(63) Continuation-in-part of application No. 12/214,550, filed on Jun. 18, 2008.

(51) Int. Cl. C12H 1/04

(52) U.S. Cl. CPC C12H 1/0432
USPC 426/271

(57) ABSTRACT

A method and device are configured to remove or reduce the quantity of one or more contaminants from a beverage, such as an alcoholic beverage. A contaminant removing material may be formed into an object or be associated with an object for contact with a beverage. The invention has particular applicability to removing or reducing the sulfite content of an alcoholic beverage and may change other properties of the beverage, such as its color. The contaminant removing material may be associated with a pour spout. The spout may also include one or more air inlets, an aeration mesh or both to aerate a beverage as it is poured. In addition, the pour spout may include one or more magnets to remove contaminants and change other properties of the beverage, such as its taste.

### RELATED APPLICATION DATA

This application claims priority to and is a continuation-in-part of U.S. patent application Ser. No. 12/214,550, filed Jun. 18, 2008, which is a continuation-in-part of U.S. patent application Ser. No. 11/974,871, filed Oct. 16, 2007, which claims priority to and is a continuation-in-part of U.S. patent application Ser. No. 11/703,584, filed Feb. 6, 2007, which claims priority to U.S. Provisional Application Ser. No. 60/855,025, filed Oct. 27, 2006 and U.S. Provisional Application Ser. No. 60/774,435, filed Feb. 17, 2006.

### FIELD OF THE INVENTION

This invention relates generally to methods for reducing undesired components, such as contaminants, from foodstuffs such as alcoholic beverages.

### RELATED ART

Foodstuffs such as beverages often contain various components which are undesirable. These components may be naturally occurring, may be additives, or may be contaminants. For example, sulfites are added to various foodstuffs including beverages for various reasons, including for stabilizing food colors and acting as preservatives to prevent spoilage due to bacteria and fungi. Sulfites are commonly found in alcoholic beverages such as wines. Wines may include up to about 3 ppm (parts per million) sulfur dioxide produced during yeast metabolism. In addition, during wine production, up to about 30 ppm of sulfites may intentionally be added. Similarly, beer and other alcoholic beverages may contain significant quantities of sulfites and other sulfur derivatives originating from metabolites and due to deliberate addition during production.

Unfortunately, some individuals are highly sensitive to certain foodstuff components such as sulfites. Such individuals may have allergic reactions upon ingesting sulfite containing foods or beverages, ranging from discomfort such as headaches to death in very severe cases.

U.S. government regulations have stringent standards regarding the level of sulfites in consumables. However, there is still a considerable industrial need to continue the use of sulfites as color stabilizers and preservatives. For individuals who are sensitive to sulfites, improved methods for reducing sulfites in alcoholic beverages are highly desirable. The safety of such individuals would be enhanced, together with their enjoyment of products that are generally available to the public, with a convenient way to remove sulfites. Correspondingly, there is a need for a convenient, easy to use, and cost effective way to remove various contaminants from beverages.

### SUMMARY OF THE INVENTION

The invention removes or reduces certain components of foodstuffs, and/or changes a characteristic or composition of a foodstuff. In a preferred embodiment, the invention may be utilized to remove or reduce the quantity of one or more contaminants from a foodstuff, and particularly an alcoholic beverage.

In one embodiment, a pour spout for altering the composition of a beverage is provided. The pour spout may have a first end and a second end and a passage through which a beverage may flow. The passage may extend from an inlet at the first end to an outlet at the second end.

Preferably, the spout includes one or more filtration media having one or more contaminant removing materials associated therewith. The materials may be associated with a filter holder. The one or more filtration media may be configured to allow the beverage to contact the contaminant removing materials, while the filter holder may be configured to hold filtration media and permit the beverage to flow there through.

In one embodiment, the spout may also include one or more magnets. The magnets may be configured to be held in a sleeve around the exterior of a beverage container adjacent to an opening of the beverage container. In other embodiments, the magnets may otherwise be located in close proximity or in contact with fluid being poured through the spout.

The pour spout may be configured with a stopper at the inlet end. The stopper may be configured to engage the opening of a beverage container and conform to the opening in one or more embodiments. In one embodiment, the one or more magnets are associated with a sleeve located radially outward of the stopper, the stopper configured to be located in an opening of the container, and the sleeve configured to be located exterior to the container, when the spout is engaged with the container.

In some embodiments, the pour spout may aerate the beverage as it is poured. For example, an aeration mesh may be included within the pour spout to aerate a beverage. In addition, one or more air inlets having an external opening and an internal opening to allow a flow of air may also be included to aerate the beverage as it is poured.

In one embodiment, the one or more contaminant removing materials comprise an ion exchange resin. The resin may be configured with a strongly basic counter-ion to entrain a substantial quantity of at least one contaminant of the beverage and thereby reduce the level of the at least one contaminant within the beverage. The ion exchange resin may be configured to remove at least one sulfite from said beverage, to change the color of the beverage, or both in one or more embodiments.

The invention may have configurations as other than a pour spout, such as a funnel or other element. In some embodiments the contaminant removing materials are associated with an object, such as a capsule located in a spout. In other embodiments, the object may be formed from the material(s).

The foregoing and other articles, features, and advantages of the invention will be apparent from the following more detailed description of the preferred embodiments of the invention. The various features may be utilized or claimed alone or in any combination.

### BRIEF DESCRIPTION OF THE DRAWINGS

FIG. 1A is an isometric view illustrating an exemplary embodiment for a stir-stick of the invention;

FIG. 1B is an isometric view illustrating an alternate embodiment of FIG. 1A, having an alternate color/pattern coding scheme;

FIG. 2A is an isometric view illustrating one embodiment of a filtration caplet for use in filtering a beverage;

FIGS. 2B and 2C are isometric views illustrating alternate embodiments of the filtration caplet of FIG. 2A;

FIG. 3A is an exploded view illustrating an exemplary embodiment of a pouring spout with integral filtration chamber;

FIG. 3B is an assembled view illustrating the pouring spout of FIG. 3A;

FIG. 3C illustrates the pouring spout of FIG. 3A operatively inserted into an exemplary beverage container;

FIG. 4A illustrates an exemplary embodiment of a pouring spout with aeration components and a plurality of magnets;

FIG. 4B is a cross sectional view of an exemplary embodiment of a pouring spout with sleeve holding a plurality of magnets around a beverage container; and

FIG. 5 illustrates another embodiment of the invention in which a beverage is poured into contact with a filtration media as it passes from one container to another container.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One or more embodiments of the invention comprise methods and apparatus/devices for removing or reducing one or more components of foodstuffs, and/or changing a characteristic or component of a foodstuff. These components may be contaminants, additives, or naturally occurring substances or elements. The invention has particular applicability to the removal or reduction of sulfites and irons in foodstuffs such as alcoholic beverages.

In the context of this disclosure, the term “sulfites” as used herein includes the salts of sulfurous acids (M₂S₂O₃), acid-sulfites or bisulfites (MHSO₃), sulfur dioxide (SO₂), metabisulfites (M₂S₂O₅), hydrosulfites (M₂S₂O₄), combinations thereof and the like, wherein M represents a cationic counter-ion comprising one or metals or non-metals such as ammonium and derivatives thereof. The term “iron” includes iron (Fe) and compounds containing iron; among other elements.

The methods and apparatus described herein may reduce the level of one or more components, such as contaminants, in a foodstuff product, such as a beverage. In one embodiment, the method and apparatus may be utilized to reduce the level of sulfites in currently available foodstuff products to substantially lower levels acceptable to individuals who are sensitive to ingestion of sulfites. Of course, the amount of sulfites may be lowered to any pre-determined level, but economic considerations in combination with the needs of allergy-susceptible individuals may favor less stringent methods.

The term “alcoholic beverage” includes any ethanol containing liquid such as wine, beer, whiskey and the like. Though the description provided herein is primarily with reference to alcoholic beverages, the methods and apparatus described herein may also be utilized in conjunction with a variety of foodstuffs other than alcoholic beverages, such as non-alcoholic beverages or other items to be ingested.

In one embodiment of the invention, a component or contaminant removing material is associated with a foodstuff, such as a beverage. As detailed below, one embodiment of the invention is a method by which a component/contaminant is removed from a foodstuff, in which a component/contaminant removing material and the foodstuff are placed in contact with one another. In one embodiment, the component/contaminant removing material is associated with an object or is formed into an object for contact with the foodstuff. Such an object may be referred to herein as a “filter” or “filtration media.”

In a preferred embodiment of the invention, the component/contaminant removing material is a sulfite removing or reducing material which is placed into contact with a sulfite containing foodstuff, such as a beverage. Various embodiments of sulfite removing or reducing materials are described in more detail below. Such materials may have a variety of forms, such as an additive, resin or the like. For example, the material may be a solid or semi-solid resin that is capable of being formed into various shapes and structures. It is contemplated that the resin may be used as a filtration media that facilitates filtering of a fluid.

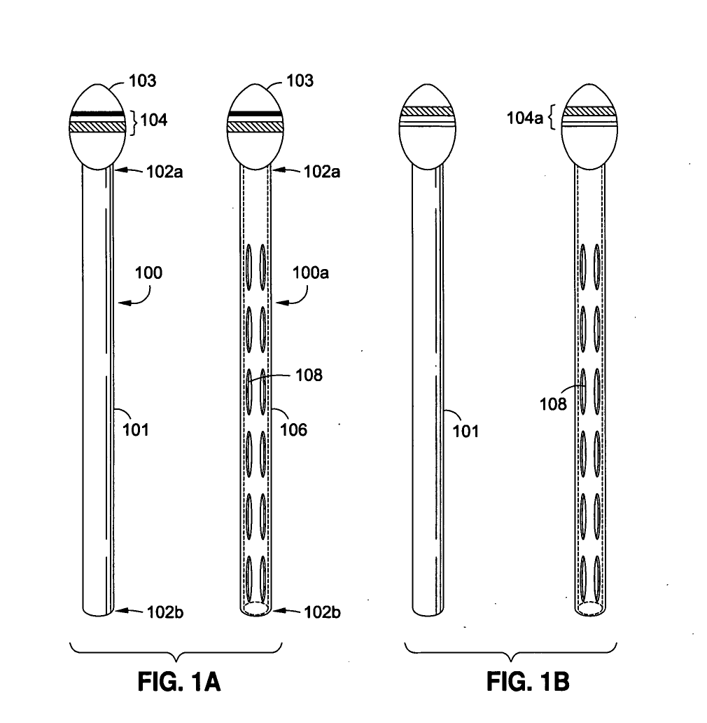

Referring now to FIG. 1A, in accordance with one embodiment of the invention, the component/contaminant removing material may be associated with an object or be formed into an object. The material might also be formed into a filter element, filtration member, filter housing or associated with an item, which may be placed into contact with the foodstuff, such as a beverage. As illustrated, such a filtration media may comprise an ornamental object, such as beverage stirrer or stir-stick 100.

In one embodiment, such as where the material is a resin, the stir-stick may be actually formed of the material. For example, the stir-stick 100 may comprise a rod-like member 101 having a first end 102a and a second end 102b. The stir-stick 100 has a handle 103 extending from or located at the first end 102a, which handle 103 may be used as a grasping portion by the user of the stir-stick. The handle 103 may have a variety of shapes and need not be constructed from the same material as the rod portion of the stir-stick (for example, the rod portion 101 may comprise component/contaminant removing resin material, while the handle may be plastic, glass or the like).

In one embodiment, the component/contaminant removing object may be marked with identifying information. Preferably, the information indicates one or more components/contaminants to be removed. The information may comprise, for example, one or more of text, numbers, colors, shapes or other indicia symbolizing one or more components or contaminants to be removed. In this manner, a user of the object(s) may select the appropriate objects to be used to remove desired components or contaminants. For example, referring to FIG. 1A, the handle 103 of the stir-stick may bear such identification information 104, such as in the form of color coding and/or recognizable patterns. As illustrated, the identification information 104 comprises one or more bands, which bands may also include color or other markings.

In another variation, the stir-stick 100a may comprise a perforated hollow member 106 which is filled with the additive. This embodiment has similar structure as previously discussed with having a first end 102a, a second end 102b, and a handle 103. However, this embodiment has a member 106 that is substantially hollow and is capped/sealed at both ends 102a,b forming a chamber therein. The chamber is used to encapsulate or contain the component/contaminate removing material. The stir-stick 100a has a plurality of fluid passages, openings, or apertures 108 formed in the hollow member 106. The passages 108 are sized to permit the beverage to flow through the passage while retaining the component/contaminant removing material within the hollow member 106. In use, as the stir-stick is moved through the beverage the fluid flows through the passages 108 and contacts the additive encapsulated within the hollow member 106.

FIG. 1B also illustrates another example of identification information 104a. In this embodiment, the information 104 comprises a different combination of bands from the embodiment illustrated in FIG. 1A. In this regard, the various objects for use in removing components/contaminants may be individually marked with identification information identifying the one or more components/contaminants to be removed. Preferably, unique identification information is provided relative to each component/contaminant (or combinations thereof) to be removed. For example, an object configured to remove sulfite may be marked with an “S” or a first combination of bands. An object configured to remove nitrates may be marked with an “N” or a second combination of bands. An object configured to remove both sulfites and nitrites may be marked with “SN” or a third combination of bands.

In one embodiment, a kit may be provided. The kit may comprise a plurality of objects configured to remove one or more different components/contaminants or combinations thereof. For example, the kit may comprise a plurality of stir-sticks comprising component/contaminant removing material or having such material associated therewith. The stir-sticks are preferably marked with identification information as detailed above. In one embodiment, a key may be provided. The key may indicate the particular component(s)/contaminant(s) which are removed by objects in relation to their coding or identification information.

As one example of use of such a kit, a plurality of wine drinkers may be seated at a table. A first party may wish to remove sulfites from their wine. That party may obtain the “sulfite removing” stir-stick by identifying it by its appropriate identification information. A second party may wish to remove nitrites from their wine. That party may obtain the “nitrite removing” stir-stick by identifying it by its appropriate identification information.

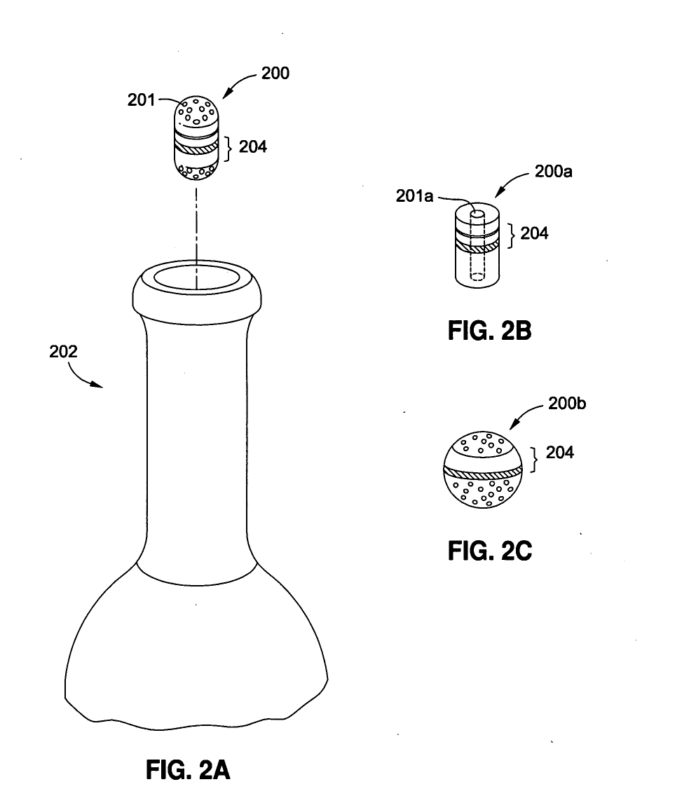

As detailed above, the component/contaminant removing material may be associated with or formed into a variety of other objects. For example, as shown in FIG. 2A, the component/contaminant removing material may be formed into a filter element such as a caplet 200 or a capsule (or other container) so as to provide a specific size or dose of material. The material may be added directly to the desired beverage, such as by dropping the caplet 200 into a container 202 containing the beverage (such as a wine bottle) or into a glass (not shown), which contains (or is to contain) the beverage.

The caplet 200 may be generally a hollow container that is permeable or have a plurality of fluid holes, passages, apertures or orifices 201 formed there through. In this embodiment, the hollow container 200 is filled with the component/contaminant removing/reducing additive. This caplet 200 permits the beverage to flow through the holes and contact the additive therein and thus remove the unwanted contaminants. The holes 201 are sized to retain the material within the caplet 200. It is contemplated and illustrated in FIGS. 2B and 2C that the caplet 200 may be configured in various geometric shapes such as a cylinder 200a, a sphere 200b or other shape capable of insertion into the beverage container 202.

In another variation, the caplet 200 may be entirely formed from the component/contaminant removing material, such as a sulfite removing ion exchange resin. This variation may also have one or more apertures, holes or cavities 201a formed thru the caplet 200 to increase the reactive surface area in contact with the beverage. Additionally the caplet 200 may have an identification information 204 associated therewith. In one embodiment, the identification information may comprise the overall shape or color of the object, such as the shape or color of the caplet 200.

In one embodiment, the component/contaminant removing material may be associated with the packaging of a foodstuff, such as a beverage. For example, one or more caplets or capsules may be placed into a package and be attached to the container containing a beverage. The “dose” of the material may be predetermined for the specific volume of the beverage in the container and/or the component/contaminant content of the beverage. Upon preparing to consume the beverage, a consumer may utilize the associated additive by opening the container and then placing the material into contact with the beverage before its consumption.

The component/contaminant removing material might otherwise be placed into contact with the beverage. For example, a portion of a container (such as a lid or cork or a bottom portion of the container) may comprise one or more component/contaminant removing materials, such as a sulfite removing or reducing additive. Of course, such material(s) may be located in any portion of the container. The material(s) may be located in a portion of the lid is separated by a permeable membrane or may comprise a portion of the lid. In use, an individual might invert the container to assure contact between the container's fluid contents and the component/contaminant removing material prior to consuming the fluid contents. In other embodiments, when a cork or lid of the container is removed, the material may be released into the container into contact with the beverage.

In yet another embodiment, a beverage may be placed into contact with the component/contaminant removing material by transferring the beverage into another container or object. For example, a beverage in a first container may be discharged into one or more intermediary containers configured to reduce component/contaminant levels, and then returned to the first container or another container prior to consumption of the beverage. It is contemplated that the intermediary container or “decanter” has component/contaminant removing material associated therewith, such as including an interior filter media (i.e., an interior surface area fabricated from or including component/contaminant removing material). Correspondingly, when the beverage is poured into the decanter, the beverage comes into contact with the material and the undesired elements within the beverage are entrained in the filter media. The beverage is then either served directly from the decanter or poured into another container for serving.

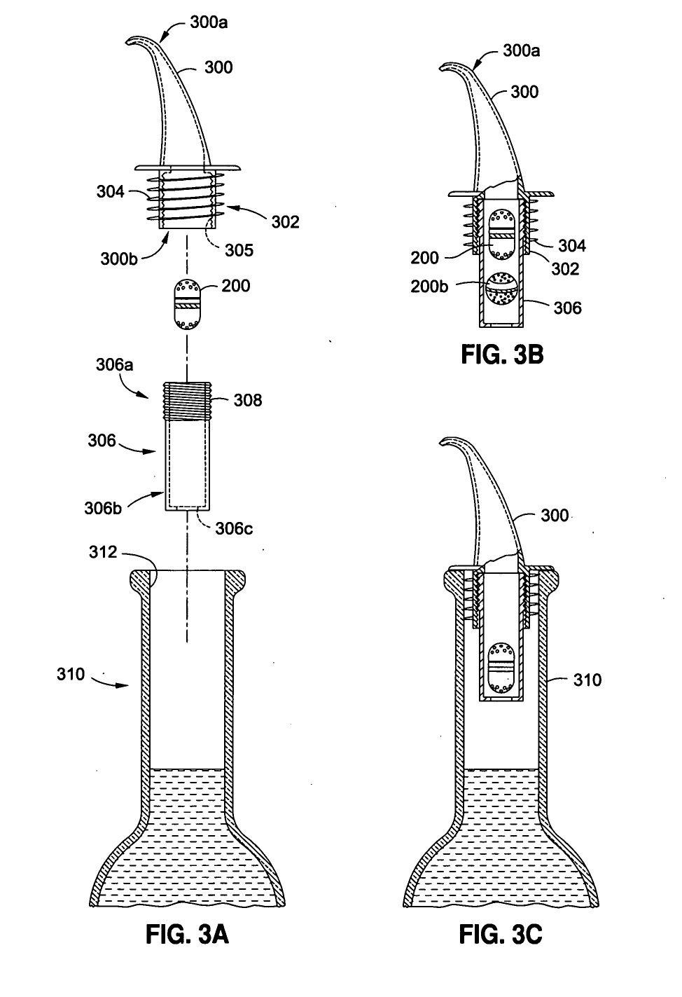

In another embodiment shown in FIG. 3A, the component/contaminant removing material may be formed into or associated with a pouring spout 300 that is removably attachable to a beverage container 310 (or other object through which the beverage is poured before consumption). In one embodiment, the pour spout 300 has a body with a first end 300A and a second end 300B. The first end is configured to engage a beverage container and may be configured as a stopper 302. The spout 300 has at least one inlet, preferably at the first end, and at least one outlet, preferably at the second end. At least one passage extends through the spout 300 from the inlet to the outlet through which fluid may be dispensed. The configuration of the pour spout 300 may vary, including by shape, size, color, material and the like. For example, while the spout 300 may be curved as it is illustrated in FIG. 3A, it might be straight.

The stopper 302 portion of the spout 300 may be configured to frictionally engage a mating portion or opening 312 in the beverage container 310. The stopper 302 has a plurality of seals 304 which are pliant and conform to the inner surface of the opening 312 and provide frictional retention of the pouring spout 300 within the beverage container 310. The stopper 302 might also be configured to screw onto or fit over the end of a bottle or other container. The stopper 302 may be a separate element assembled to the spout or may be integrally formed with the spout. In one embodiment, the stopper 302 has an opening 305 for releasable engagement and retention of a filter holder 306.

In one embodiment, the pour spout 300 is fitted with a filter holder 306 which is removably attached to the stopper 302. In use, as the beverage is poured out of the container through the spout 300, the fluid comes into contact with the component/contaminant removing material. In another embodiment, the component/contaminant removing material may be formed into the actual spout 300 or be a permeable member associated with the spout. For example, the permeable member may be a mesh-screen made out of the material.

In one embodiment, as illustrated in detail in FIGS. 3A and 3B, the pouring spout 300 may be configured to hold or contain a component/contaminant removing material. The filter holder 306 is configured to retain one or more filtration caplets 200 (discussed above) and has a fluid pathway there through. The filter holder has a first end 306a and a second end 306b. The first end 306a has a mechanical attachment means such as a threaded surface 308 for engaging a corresponding threaded surface of opening 305. It is contemplated that other mechanical attachment means may be used such as a press-fit or snap-fit configuration between the stopper and the filter holder. The second end 306b of the filter holder 306 has a retention boss 306c that prevents the caplets 200 from passing through the second end 306.

In another embodiment, the filter holder 306 (such as a pour spout 300 as illustrated in FIGS. 3A and 3B) is configured to be filled with the component/contaminant removing material such that the filter holder 306 becomes a solid column packed with the material. The first and second ends 306a,b may be fitted with a filter or fine mesh that permits the fluid to flow through the filter holder 306 while also containing the component/contaminant removing material within the filter holder 306. In this variation, the filter holder 306 essentially becomes a solid column of component/contaminant removing material and operatively filters the beverage as it passes through the holder. It is further contemplated that after filtration, the filter holder 306 may be discarded and replaced with a new holder. Conversely, after filtration, the used filter holder may be rejuvenated and reused. Additionally, the filter holder 306 may be filled with one or, more component/contaminant removing materials to provide removal of a plurality of contaminants. The filter holder 306 packed with component/contaminant removing material may also be coded as discussed above to provide visual indication of the type of contaminant that is removed with the particular material.

In operation, the pouring spout 300 is prepared for use by inserting the desired filtration caplets 200 or component/contaminant removing material in other form into the filter holder 306 and attaching the filter holder 306 to the spout (as indicated above, the component/contaminant removing material may be packed or filled into the filter holder). The pouring spout 300 is then inserted into the open end 312 of the beverage container 310. As the beverage is dispensed from the container, the beverage flows through an opening in the filter housing and across the filtration caplets. The filtration caplets entrain various contaminants contained in the beverage and prevent user consumption of the contaminants.

The invention may be configured to remove other and/or addition materials, or otherwise change characteristics of the foodstuff (such as change its taste or color). For example, the invention may be configured to remove iron or similar materials from a foodstuff, such as a beverage. In addition, the invention might be configured to otherwise alter or change the composition or a characteristic of the foodstuff. For example, the invention might be configured to aerate a beverage.

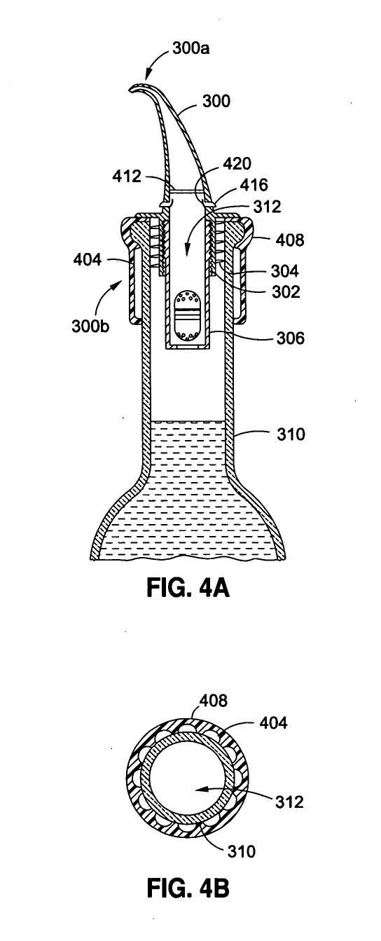

FIGS. 4A and 4B illustrate another embodiment of the invention which is configured to remove more than one contaminant from a beverage. As illustrated, the pouring spout 300 may be configured to remove iron or similar materials, such as with one or more magnets. In the embodiment shown in FIG. 4A, the pouring spout 300 has a sleeve 408 at its second end 300b which engages or is located proximal to an exterior surface of the beverage container 310. In one embodiment, such as shown in FIG. 4A, the sleeve 408 is located radially outwardly of the stopper portion of the spout, and is configured to wrap or extend around the beverage container 310 at or near its opening. The sleeve 408 is generally configured to comprise or to contain one or more magnets 404 in a manner by which the one or more magnets are in close proximity to the beverage as the beverage is poured out of the beverage container 310. As shown in the exemplary embodiment of FIG. 4B, the sleeve 408 holds the one or more magnets 404 such that the magnets are positioned around the exterior beverage container 310 at or near the beverage container's 310 opening 312. In this manner, the sleeve 408 may hold one or more magnets 404 around the neck of a wine bottle or other beverage container 310. So configured, the one or more magnets 404 are in relatively close proximity to the beverage as it is poured out the opening 312 of the beverage container 310. The magnets 404 may then filter the beverage by attracting contaminants with a magnetic force to the sides of the beverage container 310.

In one embodiment, the sleeve 408 may be a rigid structure comprising one or more portions which removably attach to one another. For example, the sleeve 408 may have two halves (or other sized portions) shaped to conform to the neck of the beverage container 300. The two halves may then be placed around the neck of the beverage container 300 and secured to each other through one or more clips, clasps, screws, flanges, or other structures. It is contemplated that the sleeve 408 may include one or more hinges in some embodiments to allow the sleeve to open and close around a beverage container 300. In addition, it is contemplated that in a rigid embodiment, a substantial portion of the sleeve 408 may be formed from magnets 404 or magnetic material. For example, the halves of the sleeve 408 may be magnets 404 secured together around the neck of the beverage container 300.

In another embodiment, the sleeve 408 is a flexible structure which may stretch or bend to accommodate the neck of a beverage container 300. In this embodiment, a series of magnets 404 may be located within a flexible sleeve 408 that can stretch or bend. The flexible embodiment of the sleeve 408 may be configured to create a fluid seal around the opening of the beverage container 300. It is contemplated that a stopper 302 or a stopper with seals 304 may not be required in embodiments where the sleeve 408 forms a fluid seal. In embodiments without a stopper 302, it is contemplated that the filter holder 306 may be directly attached, integral with, or releasably engaged to the pour spout 300 at the second end 300b.

The fluid seal may be achieved in various ways. The sleeve 408 may be configured to precisely conform to the opening of the beverage container, such as shown in FIG. 4A, or the sleeve 408 may include one or more seals, gaskets or the like, such as described above with regard to the stopper. It is noted that rigid embodiments of the sleeve 408 may also include such a fluid seal and thus not require a stopper 302 or a stopper with seals 304. Any structure capable of creating a fluid seal may be utilized. It is contemplated that some embodiments may include a fluid seal and a stopper 302 with or without seals 304.

It is contemplated that the one or more magnets 404 may be of various shapes and sizes. For example, the magnets 404 may be round, rectangular, square, or other shaped magnets. Though shown as solid elongated magnets 404 in FIG. 4A, it is contemplated that a series of smaller magnets may be positioned along the length of the sleeve 408 as well. This is advantageous in embodiments with flexible sleeves 408 because the smaller magnets allow the sleeve bend and stretch between the magnets. The magnets 404 may also be shaped to conform to the exterior of the beverage container 310 such as by having a curved surface or other conforming surface or surfaces. In addition, various types or combinations of various types of magnets 404 may be utilized. For example, the one or more magnets 404 may be neodymium, ceramic, ferrite, or other permanent magnets. It is contemplated that electromagnets with an external power source, such as a battery or a wall outlet, may be used as well. Those skilled in the art will recognize that any type of magnet now known or later developed may be utilized with the invention herein. In one embodiment, the one or more magnets might also have an annular shape (thereby extending substantially horizontally around at least a portion of the container).

Different types of magnets 404 may have different strengths and thus the ability to use various magnets with the invention is advantageous in that the degree of filtering and taste enhancement/modification, as will be discussed below, may be altered as desired through using certain types or various combinations of magnets.

The one or more magnets 404 may be associated with the sleeve 408 in various ways. For example, the interior of the sleeve 408 may be shaped to match the shape of the one or more magnets 404 such that, when inserted into the sleeve, the magnets are held in place by the sleeve. The magnets 404 may be attached to the sleeve 408 by adhesive, one or more clips, screws, covers, or other structures or fasteners. It is contemplated that the magnets 404 may be internal to the sleeve 408 as well. In addition, as stated above, it is contemplated that the sleeve 408 itself may comprise a magnetic material.

In the preferred embodiment, the magnet(s) 404 is configured to draw iron out of the foodstuff as it passes by the magnet. When the magnet(s) is located exterior to the beverage container, the iron may collect on the interior of the container and can be disposed of with the container. In other embodiments, the one or more magnets could be located in other areas, such as along the spout. For example, the spout might be longer and the magnets might be located about a flow path extending through the spout from its first end and its second end. Preferably, the magnets are located with a body or material of the spout so as to not directly contact the beverage or other foodstuff. However, the one or more magnets could be exposed. In an embodiment in which the one or more magnets are configured to attract iron particles to the spout (rather than to an interior surface of the beverage container), the object (such as the spout) may be configured to be cleaned so that it can be reused. Alternatively, it could be configured to be disposable.

Preferably, the magnets 404 are arranged to maximize the magnetic force exerted on the beverage to thereby maximize the advantages of utilizing the magnets. For example, the magnets 404 may be arranged or configured such that their poles point towards the center of the opening 312 of the beverage container 310. In this manner, the magnetic force may be efficiently applied to a beverage as it is poured from the container 310. Of course, the magnets 404 may be arranged or oriented in any manner. For example, if it is desired that less than the full magnetic force of a magnet 404 is desired, the magnet or magnets may be aligned at an angle towards the beverage's path out of the beverage container 310. It is noted that each magnet 404 may be arranged or oriented similar to or differently than some or all the other magnets of the pour spout 300.

It is noted that the one or more magnets 404 may also provide the advantage of changing/improving the taste of the beverage as well. In alcoholic and other beverages tannins and polyphenolic compounds resulting from the processing of ingredients used to manufacture these beverages impart a strong bitter or acidic flavor on the beverage. The application of a magnetic force to these beverages perceptibly reduces these unwanted flavors. In addition, beverages treated with magnets may taste like they have been aged which is highly desirable in alcoholic beverages such as wine.

In another embodiment, the invention may be configured to aerate a beverage (separately, or in addition to being configured to remove one or more contaminants). Referring to FIG. 4A, in one embodiment, the pouring spout 300 also includes aeration components such as one or more air inlets 416 and/or an aerator mesh 412 to aerate the beverage as it is poured from the beverage container 310. This aeration feature is shown in FIG. 4A in an embodiment spout which includes a sleeve 408 and one or more magnets 404. Of course, there may be embodiments where the sleeve 408 and one or more magnets 404 are provided without the aeration components of the invention and vice versa. In addition, it is contemplated that some embodiments may include one or more air inlets 416 or an aerator mesh 412 but not both.

In one embodiment, the one or more air inlets 416 extend from a point exterior to the spout (or to a point where air may be drawn into the spout) to allow air to mix with and aerate the beverage as it is poured. Aeration is advantageous in that oxidation of a beverage, such as wine, may reduce the taste of tannins and enhance fruit flavors. The flow of the beverage through the pouring spout 300 when poured may create suction which produces a flow of air through the air inlets 416 and through the pouring spout, which aerates the beverage.

Generally, the air inlets 416 are openings in the pouring spout 300 which allow air to come into contact with the beverage as it is poured. The air inlets 416 may include one or more flanges 420 located at the interior of the spout, such as illustrated in FIG. 4A, to prevent the beverage from flowing into or out of the air inlets. It is noted that flanges 420 are not required in all embodiments.

The location and number of air inlets 416 may vary, as may their configuration. For example, the air inlets 416 may comprise one or more short passages, slots or the like. The air inlets may be formed through or in the spout 300 or another structure through which the beverage is poured from a container. For example, the air inlets 416 may be positioned such that the beverage will not come into contact with the air inlets when poured. To illustrate, the beverage container 310 will be tipped a certain direction to pour a beverage in some embodiments. Thus, the beverage will flow out of the beverage container 310 along an interior side or surface of the pouring spout 300, and the air inlets 416 may be placed opposite this side or surface to prevent the beverage from flowing out the air inlets.

It is contemplated that various one way valves, fluid guides, or other structures may be used to prevent beverages from flowing out of the air inlets 416. These structures and the flanges 420 described above may take advantage of the surface tension of the beverage to prevent unwanted beverage flows as well.

In one embodiment, such as shown in FIG. 4A, the air inlets 416 are positioned above the filter holder 306 such as to allow the beverage to first be filtered by one or more filters prior to being aerated. It is contemplated that the air inlets 416 may comprise one or more channels through which air may enter the pouring spout 300. Thus, air may also enter the pouring spout below the filter holder 306 if desired. For example, an exterior opening of an air inlet 416, in contact with outside air, may be connected to an interior opening of the air inlet located below or somewhere along the length of the filter holder 306. The exterior and interior openings may be connected by one or more channels which generally comprise an air tight tube or similar structure through which air may flow.

In one embodiment, at least one air inlet may provide air to the interior of the beverage container and at least one air inlet may provide air to the beverage or other foodstuff. The first air inlet(s) may provide air to the interior of the beverage container in order to facilitate flow of the foodstuff or beverage there from (so as to replace or displace the beverage in the bottle). The second air inlet(s) may be utilized to aerate the beverage or other foodstuff. In one embodiment, the air inlets may comprise completely separate passages, such as one passage through the spout to the interior of the beverage container and another through the spout through the passage through the spout. In other embodiments, the one or more passages or vents might be common, at least in part. In order to prevent fluid from flowing out of the one or more air vents leading to the interior of the beverage container, those vents might be located at a top side of the spout or they might include a check valve or other means for allowing one-way flow of air into the bottle (and not allowing fluid to flow there through). In other embodiment, other means may be provided for allowing air to flow into to the beverage container to facilitate flow of the beverage or other foodstuff there from (for example, the spout might include a notch in the second or “stopper” portion which allows air to flow past the stopper into the beverage container).

The air and the beverage may flow through an aerator mesh 412 prior to exiting the pouring spout 300. Physical contact with the aerator mesh 412 agitates the beverage flow which exposes an increased area of the beverage to surrounding air. This introduces more of the beverage to air which correspondingly increases the level or amount of aeration. It is noted that the aerator mesh 412 may operate, though perhaps to a lessened degree, without the air inlets 416 because air may flow through an opening at the first end 300a of the pouring spout 300 to reach the aerator mesh.

Generally, the aerator mesh 412 is a permeable structure which agitates the flow of the beverage as it is poured. The aerator mesh 412 may be shaped such that the aerator mesh matches to cross section of the pouring spout 300 where the aerator mesh is positioned. For example, where the pouring spout 300 has a circular cross section the aerator mesh 412 may similarly have a circular shape. This prevents the beverage from flowing around the aerator mesh 412 when poured.

In one embodiment, the aerator mesh 412 is positioned above the filter holder 306 to allow the beverage to be filtered by one or more filters prior to aeration. In embodiments with air inlets 416, the aerator mesh 412 may be positioned above or below the interior opening of the air inlets as desired. Preferably, the aerator mesh 412 is positioned above the air inlets 416 to allow for improved aeration. It is contemplated that the aerator mesh 412 may be positioned between a plurality of air inlets 416 in one or more embodiments.

In one embodiment, the spout may define a stop which limits the extent to which the spout may be located in a beverage container. In one embodiment, the one or more air inlets are located downstream from that stop, whereby the air inlets are exposed to room air and aerate the beverage downstream of its exposure to the contaminant reducing/removing material (including the magnets).

In one embodiment, the spout or other object might include a flow controller. The flow controller is preferably configured to control the rate of flow of beverage or other foodstuff through the spout or object. This feature may be used to control the amount of time that the beverage is in contact with the contaminant reducing/removing material or the like. The configuration of the flow controller may depend upon the type of object. For example, relative to a spout, the flow controller might comprise one or more elements which may control the size of the one or more passages through the spout (i.e. open and/or close or otherwise restrict the flow passages), control the size and/or opening of air vents (thus controlling the rate of air displacement of beverage in the container) or the like. For example, the flow controller might comprise a body that can be controlled from the exterior of the spout by the user, the body moveable into and out of the passage through the spout, thus controlling the opening/closing of the passage. The flow controller might comprise a pair of aeration screens which can be twisted relative to one another, whereby the relative orientations of the screens determine how fast fluid can flow there through. Other flow controllers might comprise mechanisms that slide, compress, rotate or otherwise move or cause the configuration of the spout to change to control or manipulate the rate of flow there through.

It should be appreciated that these various aspects of the invention need not be applied to only a pour spout. For example, a funnel, stir-stick, decanter or other object might be configured with one or more contaminant removing materials, one or more magnets and/or an aerator. As also indicated, not all of the features of the invention need be applied to the single object.

In the preferred embodiment of a spout detailed above, beverage flowing through the spout contacts a contaminant removing or reducing material. In addition, the beverage is exposed to one or more magnets. Lastly, the beverage is aerated.

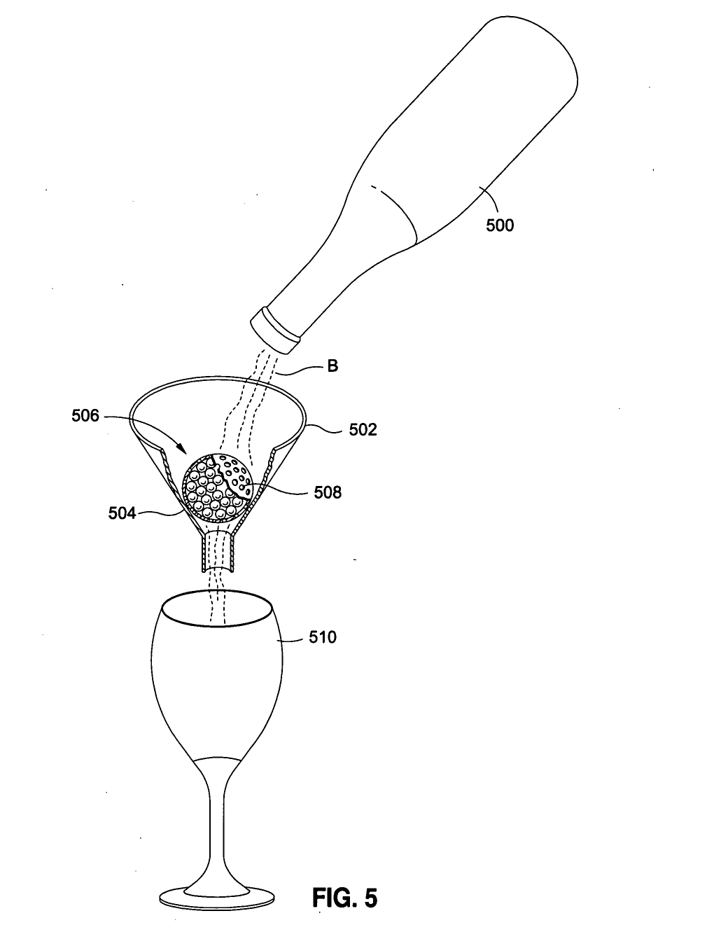

For example, another embodiment of the invention is illustrated in FIG. 5. As illustrated therein, a beverage B may be located in a first container 500. In a preferred embodiment, the beverage is wine and the first container 500 comprises a wine bottle. However, the first container 500 might comprise a carafe, a “wine box” or other type of container.

In one embodiment of the invention, the beverage is poured from the container 500 into contact with a filtration media, whereby the beverage is treated. FIG. 5 illustrates one embodiment of the invention in which the beverage is poured from the container 500 into a second container 502. In the embodiment illustrated, the second container 502 comprises a funnel which is configured to direct fluid from a first location (a wine bottle) to one or more secondary locations (such as a wine glass). Funnels are well known in the art and thus the details thereof are not provided herein. In general, however, the funnel has at least one inlet, such as an open top or first end. The funnel has at least one outlet, such as an open bottom or second end.

The beverage is poured into contact with a filtration media 504. In one embodiment, the filtration media 504 is located in filtration housing or element 506. In one embodiment, the filtration housing 506 is configured to contain a filtration media 504 and yet permit beverage to flow into contact with the filtration media 504.

For example, the filtration housing 506 may comprise a body which has at least one interior spaces and one or more openings 508 leading to the interior space(s). Preferably, the filtration media 504 is located in the interior space(s) of the housing 506. Beverage is permitted to flow into the interior space(s) and into contact with the filtration media 504.

As one example, the filtration housing 506 may comprise a generally spherical housing having a hollow interior. One or more openings 508 are formed in the body or shell of the filtration housing 506, those openings 508 lead from an exterior of the housing to the interior of the housing 506.

In one embodiment, the filtration media 504 may comprise pellets, balls, beads or other bodies of solid filtration media or bodies which are coated or covered with filtration media 504. Preferably, the size of the filtration media 504 and the size of the openings 508 in the filtration housing 506 are selected so that the filtration media 504 remains trapped or contained in the housing 508.

Of course, the filtration housing 506 might have other configurations, including other shapes. For example, the filtration housing 506 might comprise a bag, such as a fabric bag, which contains filtration media 504 and which permits beverage to flow there through.

In one embodiment, the filtration housing 506 might be openable, such as to permit the filtration media 504 therein to be removed and replaced. In this manner, the filtration housing 506 might be re-usable. In other embodiment, the entire filtration element may be disposable.

In other embodiments, the filtration media 504 might simply be configured as a free-standing body or element, rather than being located without a housing. For example, the filtration media might comprise one or more resin balls which are located directly in a funnel or the like (and thus preferably sized so that the balls do not flow through the funnel, but instead become trapped in the funnel, thus treating beverage which is poured over them). In order to increase the rate of beverage treatment, a large surface area of filtration media 504 is provided. Thus, while the filtration media 504 may be formed into balls, capsules or other bodies (or be coated or located on the exterior of a supporting body), the surface area of such media is preferably maximized to increase the rate of treatment.

As indicated, in one embodiment, a beverage may be poured from one container into contact with a filtration media to a second container. For example, as illustrated in FIG. 5, wine B may be poured from a first container (such as a wine bottle 500) into a second container, such as a funnel 502. As the wine is poured into the funnel 502, it preferably passes through the openings 508 in the filtration housing 506 and into contact with the filtration media 504 therein. The treated beverage may then be delivered to a third container, such as a wine glass 510.

Of course, the invention may have other configurations. For example, the wine might be poured into a carafe which has a filtration element therein. The treated wine may then be poured from the carafe or other serving container into another container, such as a wine glass. For example, a restaurant might treat a large container of box wine by pouring the wine into a large carafe which contains one or more filtration elements. The restaurant might then serve the treated wine by pouring glasses of wine from the carafe.

As indicated herein, in a preferred embodiment the filtration media is configured to remove sulfites from the wine. Preferably, the time that the beverage is placed in contact with the media and/or the nature of the media itself is configured to remove at least 50% of the sulfites, more preferably 60-66% or more of the sulfites. For example, wine naturally has a small amount of sulfites. Most of the undesirable sulfites are due to additives to wine to preserve the wine. Preferably, the majority of these added sulfites are removed from produced wine product before consumption (such as between the bottled wine and the wine glass). For example, in one embodiment 750 ml of wine initially containing 60 ppm of SO2 may be poured through a filtration media containing approximately 14 g of DOWEX™ 22 resin (detailed below), resulting in treated wine having approximately 22 ppm of SO2.

It is contemplated that the user may combine various types of component/contaminant removing materials to remove one or more components/contaminants from the beverage. For example, the user may insert a sulfite caplet and a polyphenol caplet into the filter holder to remove/reduce both of these contaminants during the pouring process. Conversely, the user may insert one or more of the same caplet (e.g., two sulfite caplets) to remove/reduce additional amounts of the undesired contaminant.

In an exemplary embodiment, at least a portion of the component/contaminant removing materials may comprise one or more ion exchange resins which are particularly suited to removing sulfites or reducing sulfite levels. By way of example, weakly basic anion exchange resins may include DOWEX™ 1, DOWEX™ 66 or DOWEX™ 77 manufactured by The Dow Chemical Company, U.S.A. DOWEX™ 66 and DOWEX™ 77 comprise a styrene DVB (divinyl benzene polymer) macro porous matrix including tertiary amine group functionality. The styrene DVB matrix comprises styrene cross-linked with divinyl benzene. It will be appreciated that the matrix may be any suitable polymer configured with a counter-ion. Weak anion exchange resins may be effective in reducing predominantly acidic sulfites, but not necessarily sulfites in their salt form. When the salt form of sulfites are present, a fluid may initially be de-cationized (that is the metal or non-metal counter-ion may be replaced with an acid group) with a strong acid cation exchange resin such as DOWEX™ 88 followed by treatment with a weakly basic anion exchange resin as discussed above. DOWEX™ 88 comprises a styrene DVB (divinyl benzene polymer) macro porous matrix including sulfonic acid group functionality. Of course any weakly basic and strongly acidic ion exchange resins may be suitably utilized.

In another exemplary embodiment, a strongly basic anion exchange resin such as DOWEX™ 22 may be utilized to reduce sulfites in a beverage. DOWEX™ 22 comprises a styrene DVB (divinyl benzene polymer) macro porous matrix including quaternary amine group functionality. In an embodiment of a DOWEX™ 22 ion exchange resin, the quaternary amine group functionality may be initially exchanged with hydroxyl group. The quaternary amine group may comprise trimethyl ammonium, poly (acrylamido-N-propyltrimethylammonium chloride) or any other suitable quaternary amine. The hydroxyl group of the ion exchange resin may be exchanged for sulfite anions thereby permitting entrainment sulfites in the ion exchange resin when the ion exchange resin contacts the sulfite containing fluid (alcoholic or non-alcoholic beverage). As a result, sulfite anion levels may be substantially reduced in the beverage.

In another embodiment of a DOWEX™ 22 ion exchange resin, the quaternary amine group functionality may be initially exchanged with bicarbonate anion (HCO₃⁻). The bicarbonate group of the ion exchange resin may be exchanged for sulfite anions thereby permitting entrainment sulfites in the ion exchange resin when the ion exchange resin contacts the sulfite containing fluid. Excess bicarbonate remaining in the fluid may degas as carbon dioxide (CO₂), and the fluid may subsequently achieve a slightly acidic pH as is well understood. Since the level of sulfites in most consumable beverages is very low (less than about 30-70 parts per million), an increased acidity of the fluid would be imperceptible in use.

In yet another embodiment, the quaternary amine group functionality of DOWEX™ 22 ion exchange resin may be initially exchanged with carbonate anion (CO₃²⁻). When carbonate group of the ion exchange resin exchanges for sulfite anions thereby entraining sulfites in the ion exchange resin on contact with sulfite containing fluids, any insoluble carbonates may precipitate out, while soluble carbonates will remain in solution. Again, since the level of sulfites in most consumable beverages is very low any precipitates would be imperceptible.

It will be appreciated that any weak acid anion such as bicarbonate, carbonate, acetate, phosphoric, carboxylate and combinations thereof, and the like may exchange out quaternary bases of DOWEX™ 22 ion exchange resins (or any other ion exchange resin having a quaternary base functionality). Furthermore, ion exchange resins may be suitably sized to provide greater contact area and more efficient ion exchange capability.

In accordance with the invention, other materials may be utilized to remove or reduce other components/contaminants. For example, the method and apparatus of the invention may be utilized to remove or reduce nitrites, tannins (polyphenols), histamines or other components/contaminants from a foodstuff, and preferably a beverage such as wine.

In one embodiment, the component/contaminant removing material, such as filtration media, may be rejuvenated or regenerated after one or more uses. In this manner, the material may be reused a number of times before replacement is required. The regeneration process may comprise introducing a solution that removes contaminates absorbed by the material. For example, if the decanter's filter media is configured to remove sulfites from the beverage, once the decanter is empty, a regenerating solution may be placed in the decanter which removes the entrained sulfites from the filter media and prepares the media for another operative filtration cycle.

In accordance with another aspect of the invention, a material may be utilized to change other properties of a foodstuff, and most particularly, a beverage. In one embodiment, the method and apparatus of the invention disclosed herein may be utilized to alter the coloration or appearance of a beverage. In particular, one or more materials may be introduced to the beverage for such purposes. Such materials may also have the benefit of removing one or more components or contaminants. For example, the above-referenced ion exchange resins may be utilized to remove or reduce the red coloration of a red wine.

It is contemplated that various combinations of materials may be utilized in accordance with the invention to produce a specific color change in the beverage. The material may be introduced to the beverage in a variety of ways, such as disclosed above. For example, a user may use a stir-stick, caplet or pouring spout to remove a particular component/contaminant and/or change the color of the beverage. For example, the user may decide to filter a red wine for sulfites and in the process alter the color of the wine from red to a white wine. It is contemplated that the user may customize or control the magnitude of the filtration to produce a beverage that particularly suites the user.

In operation, the invention disclosed herein may be implemented to produce a wine that is reduced with respect to particular contaminants and may also be converted to a different coloration or appearance. Altering the color of the beverage, especially wine, may be useful for both consumption by drinking and various cooking applications. For example, changing the color of wine so that the wine is less likely to cause stains, or altering the color of wine to avoid discoloring a particular recipe. By using the additive or combinations thereof, a user may convert red wine to a white wine or a combination thereof. For example, a user may produce a white Burgundy, a blush Burgundy, a white Merlot, a blush Merlot or an infinite combination of colorations and contaminant filtrations. As the user implements or selects various additives to use in removing contaminants, the coloration of the wine may also be altered to the user's particular preferences. Additionally, the more additive that is used the greater the change in coloration of the beverage. It is contemplated that the user will arrive at a particular filtration/coloration combination that is well suited for the individual tastes of that user. In this way, the method and apparatus disclosed herein provides the user with increased flexibility to customize the taste and appearance of a beverage.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method of changing the composition of wine by reducing a sulfite level of said wine before consumption thereof, comprising the steps of:
providing at least one filtration element comprising an ion exchange resin comprising a styrene DVB compound with quaternary anime group functionality; and
pouring wine which is located in a first container from said first container into contact with said resin, causing a level of at least one sulfite in said wine to be reduced before consumption.

2. The method in accordance with claim 1 wherein said filtration element comprises a housing having an interior area and said ion exchange resin is formed as a plurality of beads which are located in said housing.

3. The method in accordance with claim 2 wherein said housing comprises a shell having a plurality of flow openings from an exterior thereof to said interior area containing said plurality of beads.

4. The method in accordance with claim 1 wherein said first container comprises a wine bottle and said step of pouring comprises pouring wine from said wine bottle into an open first end of a funnel which contains said at least one filtration element.

5. The method in accordance with claim 4 further comprising the step of directing treated wine from a second end of said funnel to a wine glass.

6. The method in accordance with claim 1 wherein said step of pouring comprises pouring said wine from said first container into a second container containing said filtration element.

7. The method in accordance with claim 1 wherein said second container comprises a carafe.

8. The method in accordance with claim 6 further comprising the step of pouring treated wine from said second container to a third container.

9. The method in accordance with claim 1 wherein said third container comprises a wine glass.

10. The method of removing sulfites from wine comprising the steps of:
providing a pour spout comprising:
a body having a first end and a second end and a passage leading through said body from said first end to said second end thereof, said passage having a first portion and a second portion, said body configured to be located in an opening of a wine bottle such that said first end of said body and said first portion of said passage are positioned within said interior of said bottle and said second end of said body and said second portion of said passage are located exterior to said bottle, whereby said body prevents wine from flowing from said interior of said bottle through said opening except by said wine flowing from said interior of said bottle through said passage through said body to a point exterior to said beverage container; and
at least one filtration element located in said first portion of said passage through said body, said filtration element comprising an ion exchange resin;
locating said first end of said pour spout in an opening of a wine bottle having a quantity of wine therein so that said at least one filtration element is located in an interior of said wine bottle; and
pouring said wine from said wine bottle through said first end of said body of said pour spout into said passage thereof and into contact with said resin and out of said second end of said pour spout into a second container.

11. The method in accordance with claim 10 wherein said second container comprises a wine glass.

12. The method in accordance with claim 10 wherein said ion exchange resin comprises a styrene DVB compound with quaternary amine group functionality.

13. The method in accordance with claim 10 wherein said pour spout further comprises at least one aeration mesh located in said second portion of said passage through said body and further comprising the step of aerating said wine as it passes through said pour spout.

14. The method in accordance with claim 13 wherein said pour spout further comprises at least one air inlet extending through said second end of said body from an exterior thereof to said passage at a point between said first portion of said passage and said aeration mesh, whereby when said wine is poured there through, air is drawn from a point external to said bottle through said at least one air inlet into said wine flowing through said passage before encountering said aeration mesh.

15. The method in accordance with claim 10 wherein said pour spout further comprises one or more magnets configured to be located at an exterior of said bottle adjacent to said body when said body is connected to said bottle.
